(19) United States
(12) Patent Application Publication
(10) Pub. No.: US 2014/0152535 A1
(43) Pub. Date: Jun. 5, 2014

(54) LED BACKLIGHT DRIVER CIRCUIT, LCD DEVICE AND DRIVING METHOD

(71) Applicant: Shenzhen China Star Optoelectronics Technology co. Ltd, Shenzhen (CN)

(72) Inventors: Hua Zhang, Shenzhen (CN); Fei Li, Shenzhen (CN)

(21) Appl. No.: 13/807,276

(22) PCT Filed: Dec. 7, 2012
(86) PCT No.: PCT/CN2012/086096

§ 371 Date: Dec. 27, 2012

(30) Foreign Application Priority Data
Nov. 30, 2012 (CN) 201210501289.6

(51) Int. Cl. H05B 33/08; G09G 3/36

(52) U.S. Cl. CPC H05B 33/0815; G09G 3/36
USPC 345/102; 315/186

(57) ABSTRACT

A light emitting diode (LED) backlight driver circuit includes at least two lightbars which are independently driven, an output end of each lightbar is coupled with a constant current driver integrated circuit (IC), and a monitoring module controlling the constant current driver IC. The monitoring module outputs a phase delay time to drive each lightbar and a current duty of each lightbar to the constant current driver IC, and the constant current driver IC drives the lightbars one by one according to the corresponding current duty in accordance with the phase delay time in sequence.

### TECHNICAL FIELD

The present disclosure relates to the field of liquid crystal displays (LCDs), and more particularly to a light emitting diode (LED) backlight driver circuit, an LCD device, and a driving method.

### BACKGROUND

At present, all shutter glass three-dimensional (3D) liquid crystal display (LCD) TV sets on the market employ a serial peripheral interface (SPI) bus system. In a 3D mode of the LCD TV sets, a light emitting diode (LED) backlight constant current driver integrated circuit (IC), which supports the SPI, receives an enable signal (CS), a clock signal (SCK), and an output data signal (SDA), which are sent by a timing control circuit (TCON), decodes a current duty and a phase delay time of corresponding LED lightbar. The LED backlight constant current driver IC further controls a light-dark time and sequence of all LED lightbars of the LCD TV by a dimming metal-oxide-semiconductor field-effect transistor (MOSFET) of the IC, and completes an LED backlight scanning in the 3D mode (as shown in FIG. 1A and FIG. 1B). The output data signal (SDA) of the SPI is not achieved directly. When an LED backlight driver malfunctions and needs to be repaired or replaced, whether the data transmitted by the TCON is right is only known by decoding the SDA. In addition, the constant current driver IC which supports the SPI is used, and then design cost may be increased.

### SUMMARY

In view of the above-described problems, the aim of the present disclosure is to provide a light emitting diode (LED) backlight driver circuit, a liquid crystal display (LCD) device and a driving method thereof with the advantages of low cost and convenient commissioning.

The aim of the present disclosure is achieved by the following technical scheme.

An LED backlight driver circuit comprises at least two lightbars that are independently driven, an output end of each of the lightbars is coupled with a constant current driver integrated circuit (IC), and a monitoring module that controls the constant current driver integrated circuit (IC). The monitoring module outputs the drive delay time to drive each lightbar and the current duty of each lightbar to the constant current driver IC, and the constant current driver IC drives the lightbars one by one according to the corresponding duty in accordance with the delay time in sequence.

Furthermore, the monitoring module obtains an enable signal (CS), a clock signal (SCK) and an output data signal (SDA) from the serial peripheral interface (SPI) of the LED backlight driver circuit, decodes and generates duty (current duty) and delay time (phase delay) for each of the LED lightbars, and directly sends the duty and the delay time to the constant current driver IC. The technical scheme can be applied to various constant current driver ICs by directly controlling single monitoring module without changing the timing control circuit (TCON).

Furthermore, the monitoring nodule outputs the drive signals of all the lightbars to the constant current driver IC in sequence according to the delay time. This is a technical scheme for outputting drive signals in real time. The monitoring module outputs the drive signal of the lightbar in need to the constant current driver IC without determinating an integrity of the drive signal of the lightbar in need by the constant current driver IC. Thus, the design of the constant current driver IC is further simplified, and the cost is reduced.

Furthermore, the constant current driver IC is configured with input pins corresponding to each of the lightbars, and the monitoring module outputs the drive signal of each lightbar into the corresponding input pin. This is a specific circuit structure of the constant current driver IC. The input pins are in one-to-one correspondence with the output pins used to control the lightbars. The drive signal of the monitoring module can directly drive the ON/OFF of the corresponding lightbar without switching the drive signal of the monitoring module to the corresponding lightbar by the constant current driver IC. Thus, the design of the constant current driver IC can be further simplified, and the cost can be reduced.

Furthermore, the constant current driver IC is only configured with one input pin for each of the LED lightbars, the monitoring module inputs the drive signals of all the lightbars into the corresponding input pins, where the constant current driver IC comprises a switching module switching the drive signals of the input pin to the corresponding lightbars. The technical scheme may reduce the control lines between the monitoring module and the constant current driver IC, simplify the circuit board design and save the circuit space.

Furthermore, the monitoring module sends the drive delay time to drive two adjacent lightbars together with the current duty of all the lightbars to the constant current driver IC within one scanning period. The one scanning period is the a time to drive from a first lightbar to a last lightbar. In the technical scheme, the time to drive the lightbar and the lightbar which is driven is determinated by the constant current driver IC in accordance with the phase delay time and the current duty of the lightbar, thereby reducing load of the timing control circuit and reducing design costs of the timing control circuit.

Furthermore, the monitoring module is a timing control module. This is a specific monitoring module. Function of the monitoring module is achieved by using the timing control circuit without additionally adding hardware structure, thereby reducing hardware cost.

An LCD device comprises the aforementioned LED backlight driver circuit.

An LED backlight driving method comprises steps:

A. employing a monitoring module to generate a phase delay time between two lightbars and a current duty of each lightbar, and sending the phase delay time to drive each lightbar and the current duty of each lightbar to a constant current driver integrated circuit (IC);

B. outputting the drive signals of each of the lightbars in sequence in accordance with the delay time by the constant current driver IC.

Furthermore, in the step A, the drive signal of each of the lightbars are output to the constant current driver IC in sequence according to the delay time by the timing control circuit. This is a technical scheme for outputting drive signals in real time. The monitoring module outputs the drive signal of the lightbar in need to the constant current driver IC without determinating an integrity of the drive signal of the lightbar in need by the constant current driver IC. Thus, design of the constant current driver IC is simplified, and costs are reduced.

Furthermore, the constant current driver IC is configured with input pins for each of the LED lightbars. In the step A, the monitoring module inputs the drive signal of each lightbar into the corresponding input pin.

This is a specific circuit structure of the constant current driver IC. The input pins are in one-to-one correspondence with the output pins used to control the lightbars. The drive signal of the monitoring module may directly drive the ON/OFF of the corresponding lightbar without switching the drive signal of the monitoring module to the corresponding lightbar by the constant current driver IC. Thus, the design of the constant current driver if can be further simplified, and the cost can be reduced.

In the present disclosure, because the drive delay time to drive two adjacent lightbars and the current duty of each lightbar are output to the constant current driver IC by the monitoring module, the constant current driver IC can directly output the control signals of each lightbar in accordance with the aforementioned two signals without performing further decoding and analyzing the aforementioned two signals, thereby being more convenient and reducing repair and replacement costs. Meanwhile, because there is no need to decode the signals outputted by the monitoring module through a serial peripheral interface (SPI), ordinary constant current driver ICs can be used, and application scope of the constant current driver IC is expanded.

### BRIEF DESCRIPTION OF FIGURES

FIG. 1A is a schematic diagram of a driving waveform of a timing control circuit (TCON) in the prior art;

FIG. 1B is a schematic diagram of a backlight driver corresponding to FIG. 1A;

FIG. 2 is a schematic diagram of the present disclosure;

FIG. 3 is a schematic diagram of a first example of the present disclosure; and

FIG. 4 is a schematic diagram of a second example of the present disclosure.

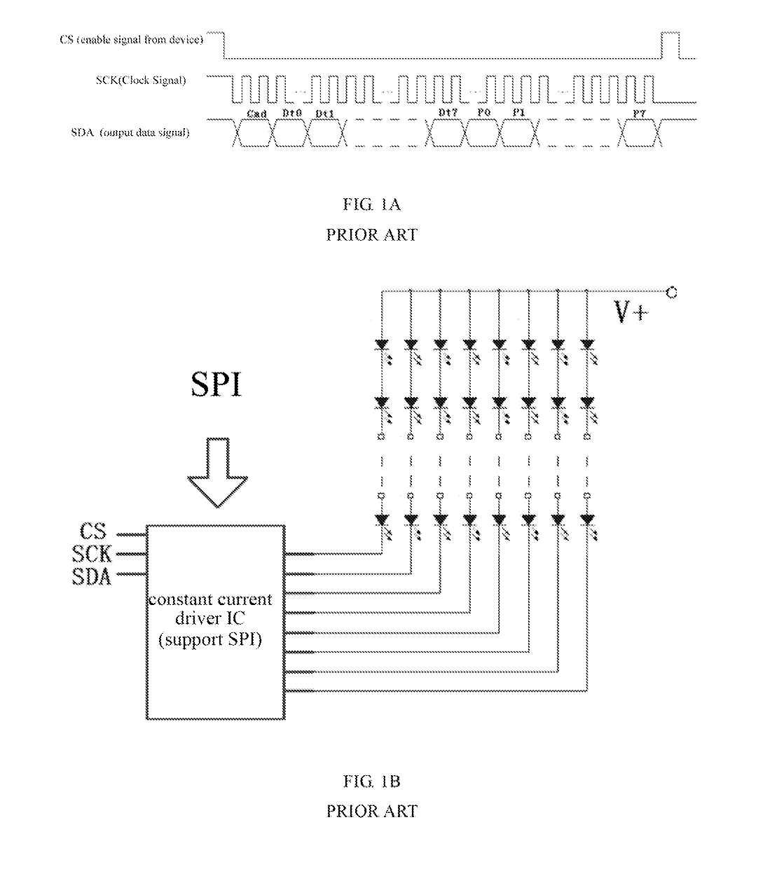

Legends: 1. LED lightbar; 2. constant current driver IC.

### DETAILED DESCRIPTION

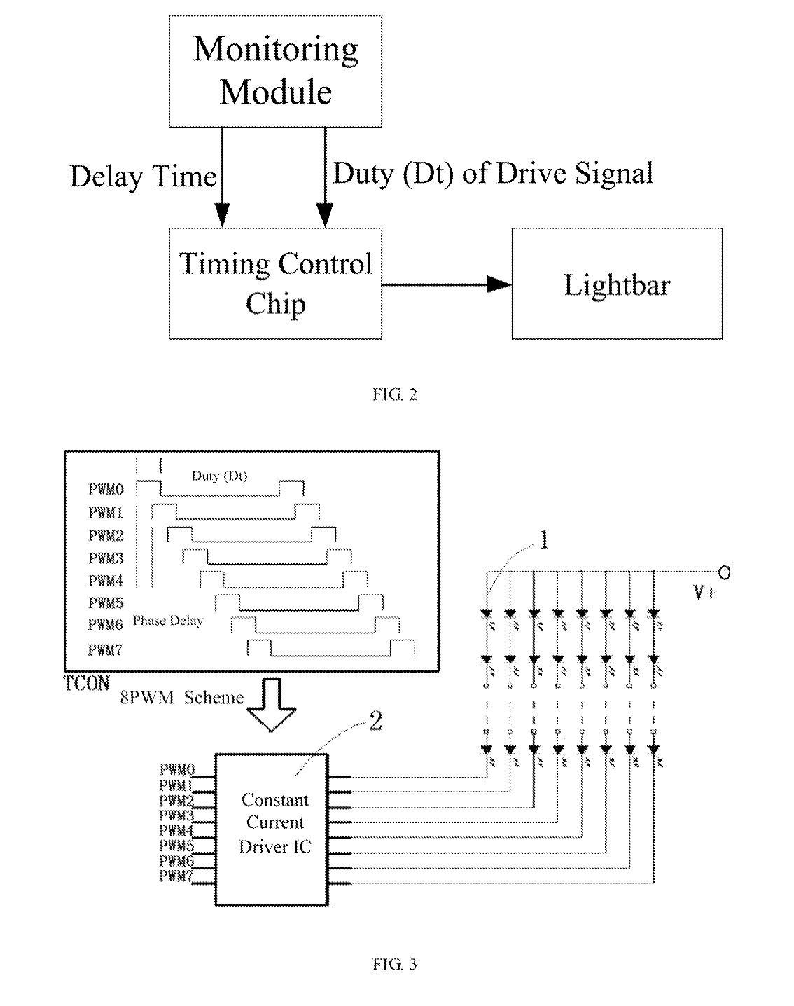

The present disclosure provides a liquid crystal display (LCD) device comprising a light emitting diode (LED) backlight driver circuit. As shown in FIG. 2, the LED backlight driver circuit comprises at least two lightbars that are independently driven, an output end of the lightbar is coupled with a constant current driver integrated circuit (IC), and a monitoring module that controls the constant current driver IC. The monitoring module outputs a phase delay time to drive two adjacent lightbars and a current duty of each lightbar to the constant current driver IC, and the constant current driver IC drives the lightbars one by one according to the corresponding current duty in accordance with the phase delay time in sequence.

In the present disclosure, because the phase delay time to drive the two adjacent lightbars and the current duty of each lightbar are outputted to the constant current driver IC by the monitoring module, the constant current driver IC may directly output a control signal of each lightbar in accordance with the aforementioned two signals without decoding and analyzing the aforementioned two signals, thereby being convenient and reducing repair and replacement costs. Meanwhile, because there is no need to decode the signals outputted by the monitoring module through a serial peripheral interface (SPI), ordinary constant current driver ICs can be used, and application scope of the constant current driver IC is expanded. The present disclosure is not only used in a backlight driver of a three-dimensional (3D) display, but also controls brightness of different display areas of a two-dimensional (2D) display to enable brightness of the lightbar corresponding to a area with dark display image to be correspondingly reduced, so as save energy and reduce energy consumption.

The present disclosure will further be described in detail in accordance with the figures and the exemplary examples.

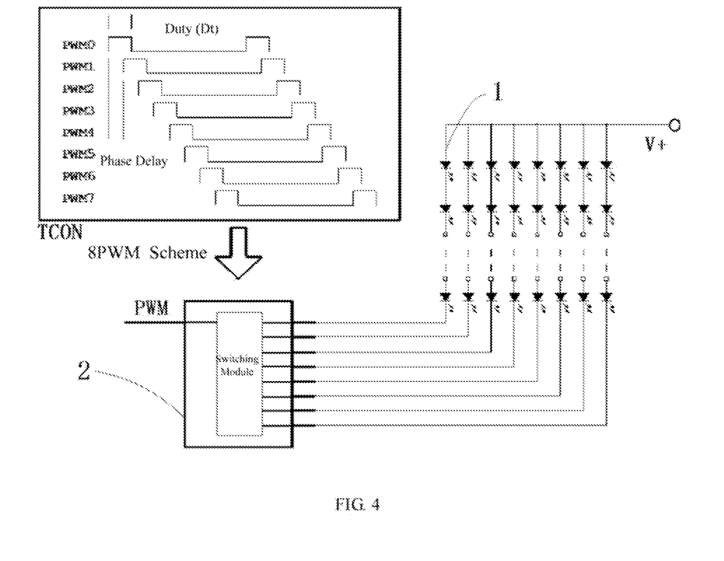

As shown in FIG. 3, there are eight lightbars 1 in the example, and an output ends of the lightbars 1 are respectively connected to eight output pins of a constant current driver IC 2. Other end of the constant current driver IC 2 is further configured with eight input pins which are in one-to-one correspondence with the eight output pins. A timing control circuit (TCON) outputs drive signals (PWM 0-PWM 7) of all the lightbars 1 in sequence to the corresponding input pins of the constant current driver IC 2 according to a set phase delay time (phase delay time shown in the FIG. 3).

This is a technical scheme for outputting drive signals in real time. Function of the monitoring module is achieved by using the timing control circuit without use of additional hardware structure, thereby reducing hardware cost. The timing control circuit outputs the drive signal of the lightbar 1 in use to the constant current driver IC 2 without determinating a integrity of the drive signal of the lightbar 1 in use by the constant current driver IC 2. Thus, design of the constant current driver IC 2 is simplified, and costs are reduced. The input pins are in one-to-one correspondence with the output pins controlling the lightbars 1. The drive signal of the monitoring module may directly drive ON/OFF of the corresponding lightbar 1 without switching the drive signal of the monitoring module to the corresponding lightbar 1 by the constant current driver IC 2. Thus, the design of the constant current driver IC 2 may be further simplified, and costs may be reduced. The scheme may be applied to the 3D backlight driver, and may be applied to some 2D modes of the LCD devices so that energy consumption may be reduced.

### EXAMPLE 2

As shown in FIG. 4, the constant current driver IC 2 in the example is only configured with one input pin (PWM) for each of the LED lightbars 1, the drive signals (PWM 0-PWM 7) of all the lightbars 1 are input into the input pin (PWM) by the timing control circuit, a switching module switching the drive signals (PWM 0-PWM 7) of the input pin to the corresponding lightbars 1 is arranged in an inside of the constant current driver IC 2. Control lines between the timing control circuit and the constant current driver IC 2 are reduced in the example, simplifying circuit board design and saving circuit space.

### EXAMPLE 3

In the example, the timing control circuit sends the phase delay time to drive two adjacent lightbars together with the current duty of all the lightbars to the constant current driver IC within one scanning period. The one scanning period is a time to drive from a first lightbar to a last lightbar. In the example, the time to drive the lightbar and the lightbar which is driven is determinated by the constant current driver IC in accordance with the phase delay time and the current duty of the lightbar, thereby reducing load of the timing control circuit and reducing design costs of the timing control circuit.

### EXAMPLE 4

The present disclosure further provides an LED backlight driving method, comprising steps:

A. employing a monitoring module to generate a phase delay time between two adjacent lightbars and a current duty of each lightbar, and sending the phase delay time to drive each lightbar and the current duty of each lightbar to a constant current driver IC;

B. driving the lightbars one by one in accordance with the corresponding current duty in sequence according to the phase delay time by the constant current driver IC. The constant current driver IC, is configured with input pins for each of the LED lightbars. In the step A, drive signals of all lightbar are outputted to the constant current driver IC in sequence according to the phase delay time by the timing control circuit. The timing control circuit inputs the drive signals of all the lightbar to corresponding input pins.

Function of the monitoring module is achieved by using the timing control circuit without additionally adding hardware structure, thereby reducing hardware cost. The timing control circuit outputs the drive signal of the lightbar 1 which needs to be driven to the constant current driver IC 2 without a determination of the constant current driver IC 2. Thus, design of the constant current driver IC 2 is simplified, and costs are reduced. The input pins are in one-to-one correspondence with the output pins controlling the lightbars 1. The drive signal of the monitoring module may directly drive ON/OFF of the corresponding lightbar 1 without switching the constant current driver IC 2. Thus, the design of the constant current driver IC 2 may be further simplified, and costs may be reduced.

The invention is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A light emitting diode (LED) backlight driver circuit, comprising:
at least two lightbars which are independently driven; and
a monitoring module;
wherein an output end of each of the lightbars is coupled with a constant current driver integrated circuit (IC), the monitoring module controls the constant current driver integrated circuit (IC) and outputs a phase delay time to drive each lightbar and a current duty of each lightbar to the constant current driver IC, and the constant current driver IC drives the lightbar one by one according to the corresponding current duty in accordance with the phase delay time in sequence.

2. The light emitting diode (LED) backlight driver circuit of claim 1, wherein the monitoring module obtains an enable signal (CS), a clock signal (SCK), and an output data signal (SDA) from a serial peripheral interface (SPI) of the LED backlight driver circuit, decodes and generates a current duty and the phase delay time for each of the LED lightbars, and directly sends the current duty and the phase delay time to the constant current driver IC.

3. The light emitting diode (LED) backlight driver circuit of claim 1, wherein the monitoring module outputs drive signals of all the lightbar in sequence to the constant current driver IC according to the phase delay time.

4. The light emitting diode (LED) backlight driver circuit of claim 3, wherein the constant current driver IC is configured with input pins corresponding to each of the lightbars, and the monitoring module inputs the drive signals of all the lightbar into the corresponding input pins.

5. The light emitting diode (LED) backlight driver circuit of claim 3, wherein the constant current driver IC is configured with only one input pin for each of the LED lightbars, the drive signals of all the lightbars are input to the input pin by the monitoring module, wherein the constant current driver IC comprises a switching module switching the drive signals of the input pin to the corresponding lightbars.

6. The light emitting diode (LED) backlight driver circuit of claim 1, wherein the monitoring module sends a phase delay time to drive two adjacent lightbars together with the current duty of all the lightbars to the constant current driver IC within one scanning period, wherein the one scanning period is a time to drive from a first lightbar to a last lightbar.

7. The light emitting diode (LED) backlight driver circuit of claim 1, wherein the monitoring module is a timing control module.

8. A liquid crystal display (LCD) device, comprising:
a light emitting diode (LED) backlight driver circuit, wherein the LED backlight driver circuit comprises at least two lightbars which are independently driven, an output end of each lightbar is coupled with a constant current driver integrated circuit (IC), and a monitoring module controlling the constant current driver IC; the monitoring module outputs a phase delay time to drive each lightbar and a current duty of each lightbar to the constant current driver IC, and the constant current driver IC drives the lightbar one by one according to the corresponding current duty in accordance with the phase delay time in sequence.

9. The liquid crystal display (LCD) device of claim 8, wherein the monitoring module obtains an enable signal (CS), a clock signal (SCK), and an output data signal (SDA) from a serial peripheral interface (SPI), decodes and generates the current duty and the phase delay time for each of the LED lightbars, and directly sends the current duty and the phase delay time to the constant current driver IC.

10. The liquid crystal display (LCD) device of claim 8, wherein the monitoring module outputs drive signals of all the lightbars in sequence to the constant current driver IC according to the phase delay time.

11. The liquid crystal display (LCD) device of claim 10, wherein the constant current driver integrated circuit (IC) is configured with input pins for each of the LED lightbars, and the monitoring module inputs the drive signals of all the lightbars into the corresponding input pins.

12. The liquid crystal display (LCD) device of claim 10, wherein the constant current driver integrated circuit (IC) is only configured with one input pin for each of the LED lightbars, the monitoring module inputs the drive signals of all the lightbars into the corresponding input pins, wherein the constant current driver IC comprises a switching module switching the drive signals of the input pin to the corresponding lightbars.

13. The liquid crystal display (LCD) device of claim 8, wherein the monitoring module sends a phase delay time to drive two adjacent lightbars together with the current duty of all the lightbars to the constant current driver integrated circuit (IC) within one scanning period; wherein the one scanning period is a time from driving a first lightbar to a last lightbar.

14. The liquid crystal display (LCD) device of claim 8, wherein the monitoring module is a timing control module.

15. A light emitting diode (LED) backlight driving method, comprising:
A. employing a monitoring module to generate a phase delay time between two lightbars and a current duty of each lightbar, and sending the phase delay time to drive each lightbar and the current duty of each lightbar to a constant current driver integrated circuit (IC);
B. driving the lightbars one by one in accordance with the corresponding current duty in sequence according to the phase delay time by the constant current driver IC.

16. The light emitting diode (LED) backlight driving method of claim 15, wherein in the step A, the timing control circuit outputs drive signals of all the lightbars to the constant current driver IC in sequence according to the phase delay time.

17. The light emitting diode (LED) backlight driving method of claim 16, wherein the constant current driver IC is configured with input pins for each of the LED lightbars; in the step A, the monitoring module inputs the drive signals of all the lightbars into the corresponding input pins.
